(19) United States
(12) Patent Application Publication
(10) Pub. No.: US 2010/0333106 A1
(43) Pub. Date: Dec. 30, 2010

(54) REORGANIZATION PROCESS MANAGER

(75) Inventors: Nigel KING, San Mateo, CA (US); Daniela KANTOROVA, Belmont, CA (US); Neil RAMSAY, Madrid (ES)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/490,511

(22) Filed: Jun. 24, 2009

(51) Int. Cl. G06F 9/46

(52) U.S. Cl. 718/106

(57) ABSTRACT

Systems and methods provide a platform for facilitating organizational restructuring. The system receives an organizational chart representing the organizational restructuring and applies business processes defining tasks that implement the organizational restructuring. The system manages communication among organizational entities based upon a task dependency model for the various tasks that implement the reorganization. The system then uses the task dependency model to determine that the organizational restructuring is complete.

### FIELD OF THE INVENTION

One embodiment is directed generally to organizational restructuring, and more particularly to a computer system for facilitating the restructuring of an organization.

### BACKGROUND INFORMATION

An organizational restructuring/reorganization, necessitated, for example, by the merger between two companies or an acquisition of another company, is a long running process that impacts many departments. The process requires planning, organization, collaboration and coordination, and may be very expensive for a company to execute. The impact of the reorganization in terms of the reporting lines of people, responsibility for budgets, expenses and headcount currently happen without any automation assistance. The financial planning of both managers trying to understand their spending patterns and analysts allocating budgets and forecasts is clouded by having a organization hierarchy that is discontinuous. The communications between the reorganization initiators and the reorganization implementers is ad hoc. Reorganization initiators may include corporate finance officers, corporate strategy officers, or mergers and acquisitions consultants. The implementers of the reorganization may include human resource heads, maintenance and space planning heads, wiring and communications heads, and project management heads. The overall task list will be derived through corporate experience gained through trial and error. Communications will likely occur via email and phone, and project and task tracking will likely occur through spreadsheets.

### SUMMARY OF THE INVENTION

One embodiment is a system for facilitating organizational restructuring. The system receives an organizational chart representing the organizational restructuring and applies business processes defining tasks that implement the organizational restructuring. The system manages communication among organizational entities based upon a task dependency model for the various tasks that implement the reorganization. The system then uses the task dependency model to determine that the organizational restructuring is complete.

### BRIEF DESCRIPTION OF THE DRAWINGS

FIG. 1 is a block diagram of a system that can implement a reorganization collaboration tool (“RCT”) in accordance with an embodiment.

FIG. 2 illustrates a logical diagram of a simple example reorganization in accordance with an embodiment.

FIG. 3 illustrates a reorganization collaboration tool platform in accordance with an embodiment.

FIG. 4 illustrates an example dependency diagram depicting organizational and departmental dependencies in accordance with an embodiment.

FIG. 5 illustrates a flow diagram of the functionality of an RCT in accordance with an embodiment.

FIG. 6 is a block diagram of an example data structure that can implement the task dependencies of FIG. 4 in accordance with one embodiment.

FIG. 7 illustrates a user interface that displays the “As Is” and “To Be” organization charts in accordance to one embodiment.

FIG. 8 illustrates a user interface that provides a unified view of tasks for a reorganization in accordance to one embodiment.

### DETAILED DESCRIPTION

An embodiment is directed to a web-based reorganization collaboration tool that contains standard processes for reorganizations that work with enterprise applications such as financial planning and modeling, general ledger, human resources and security applications. These process definitions span the departments that use the enterprise applications and perform most of the initiation and implementation of the reorganization. The reorganization tool allows a comparison between an “as is” organizational hierarchy and a “to be” organizational hierarchy, and distills from this comparison the “organizational change.” The tool provides executives and managers with a user interface for reviewing the organizational change and, if so approved, to initiate that reorganization process. Key participants in this process include, but are not limited to: a reorganization coordinator, financial analyst, general accountant, human resource specialist, security manager, managers, and many other employees. Each participant is notified at the appropriate phase of the overall process when their approval is needed, or when a task has been completed.

In the first phase, executives and managers may be provided with a project budget that has been modeled in the template for the type of reorganization. They identify the people and departments involved in the reorganization and submit the reorganization to the reorganization tool, which notes which tasks are complete and informs managers of affected departments. Meanwhile, the initiation of the reorganization process may be routed to financial planners, where the “to be” organization hierarchy may be imported into financial modeling software. The impacts on accounts may be derived, financial reporting hierarchies changed, and budgets and forecasts moved based on the reorganization. Once complete, changes to a line manager's authorization to see financial reports may be routed to security administration and the tasks in financial planning are marked as complete. Approvals that were charged to responsible managers whose cost centers have changed may be redirected to a new responsible manager. The reorganization tool may notify the human resources department regarding the completion of other departments' activities. Accordingly, a human resources specialist may review the impacts to departments, departmental managers and departmental hierarchy and make the changes to reporting relationships between managers and subordinates using the reorganization tool.

Departments represent the internal structure or organization deployed to meet business objectives or responsibilities. Departments are assigned managers who are accountable for compliance with business objectives or responsibilities; and other managers and workers that carry out the associated day to day tasks. However, departments are independent of the managers and workers assigned to them in the sense that human resource changes do not necessarily result in changes the department structure. For example, if the manager of the marketing department changes, the marketing department has the same objectives and responsibilities, and the same relationship to other departments in the organization. Since departments represent the operational, as opposed to financial structure, of the enterprise, they are not tied to legal or national boundaries. For example, many centralized departments of large multi-nationals have managers and workers employed (i.e., contracted) in many countries.

The financial performance of departments is tracked in one embodiment through a cost center component of an integrated accounting computer system. However, cost centers do not exist only to track expenses of departments. Typically, cost centers represent the lowest common denominator of a wide range of analytics reporting “attributes” of expenses and revenue, one of which is department. For example, each cost center may represent a unique combination of three “attributes”: department, legal entity and recent acquisition. Cost center “attributes” may include a wide range of financial and operational dimensions such as financial function, reporting code, location, etc.

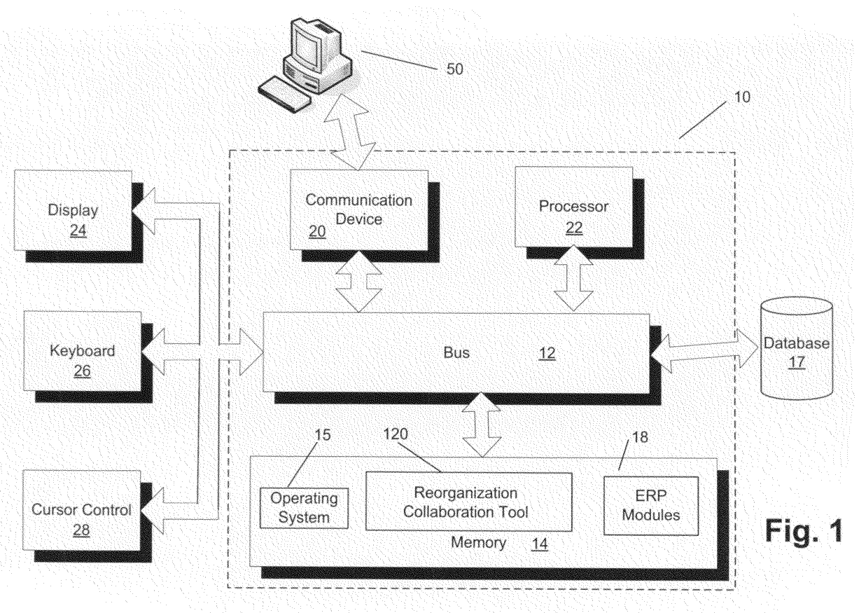

FIG. 1 is a block diagram of a system 10 that can implement an embodiment of a reorganization collaboration tool (“RCT”). System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network (such as the Internet) or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include RCT 120. This module is described in greater detail below. The modules may include enterprise resource planning (“ERP”) modules 18 of an ERP system that may interact with RCT 120. An ERP system is a computer system that integrates several data sources and processes of an organization into a unified system. A typical ERP system uses multiple components of computer software and hardware to achieve the integration. A unified ERP database 17, coupled to bus 12, is used to store data for the various system modules. In one embodiment, ERP modules 18 are part of the “Oracle Fusion Applications” from Oracle Corp. In other embodiments, RCT 120 may be a stand-alone system and not integrated with an ERP system, or may be part of any other integrated system. In some embodiments, the functions of RCT 120, described below, are directed and utilized remotely from a user's computer 50 through communication device 20 and function as a Software as a Service (“SaaS”).

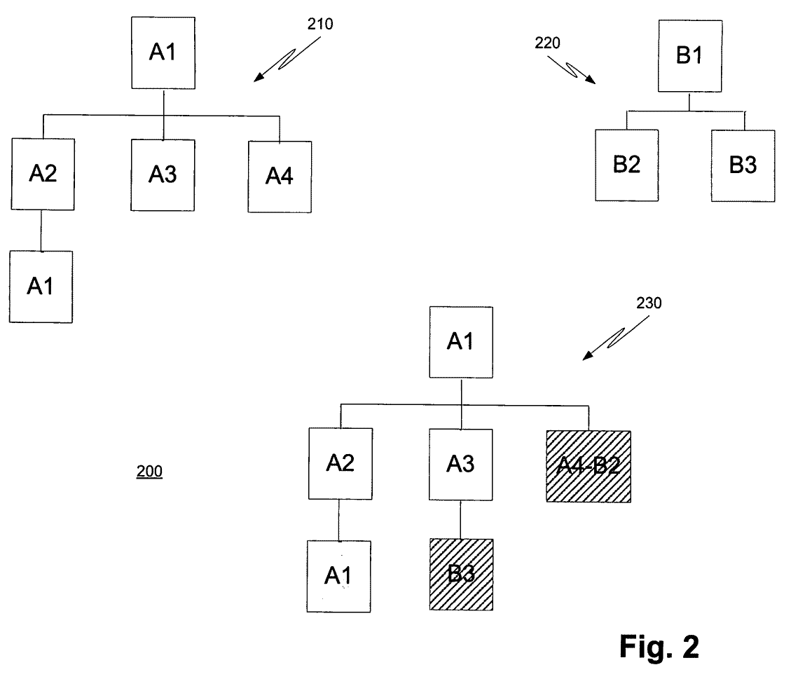

FIG. 2 illustrates a logical diagram of a simple example reorganization 200, in this case a merger, in accordance with an embodiment. In this example, organization 210 has acquired organization 220, and the executives and reorganization planners of organization 210 determine reorganization chart 230 highlighting the changes to organization 210. Organization 210 includes departments A1, A2, A3, A4, A5 and organization 220 includes departments B1, B2, B3. The reorganization ultimately results in the dissolution of department B1, the merger of departments A4 and B2, and the movement of B3 under department A3, as shown in the reorganization chart 230. Organizational changes are represented by shaded boxes. Although a merger is shown in FIG. 2, embodiments can support changes resulting from any type of reorganization, including a divestiture, acquisition, merger, or an internal reorganization. The changes may include department hierarchy changes, cost center hierarchy changes, changes of worker assignments, changes to budgets, quotas, and forecasts, etc.

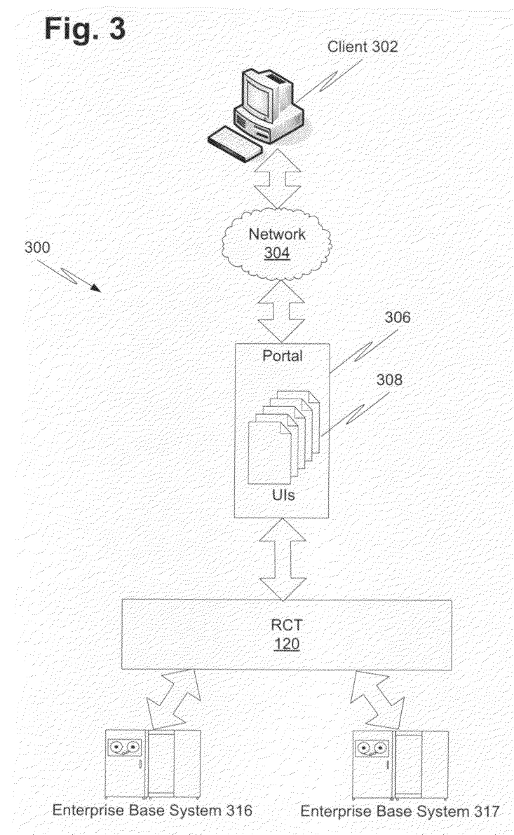

FIG. 3 illustrates a reorganization collaboration tool platform 300 in accordance with an embodiment. Platform 300 represents logically a physically distributed information system representing multiple enterprise information systems of organizations. Platform 300 includes multiple clients 302 accessing RCT 120 over network 304 through portal 306. In one embodiment, clients 302 are processes and/or web browsers that are coupled to network 304 through a proxy server (not shown). Portal 306 provides a common interface to program management services through user interface (“UI”) components 308. Portal 306 communicates with RCT 120, which manages the reorganization process. RCT 120 provides integrated application services to manage business objects and processes in a business enterprise. The business objects and processes may include resources such as personnel, cost centers, development projects, business programs, inventories, clients, accounts, business products, business services, etc.

In an embodiment, platform 300 includes enterprise base systems 316 and 317, which are the enterprise information systems of two organizations to be merged. RCT 120 communicates with enterprise base systems 316 and 317 to obtain multiple types of enterprise base system data. The base systems 316 and 317 include application services, such as human resource management systems, customer relationship management services, financial management systems, project management systems, knowledge management systems, business warehouse systems, time management systems, electronic file systems and mail systems. RCT 120 consolidates and integrates the data and functionality of enterprise base systems 316 and 317 into the single management tool. A virtual business cycle can be generated using RCT 120, where executive level business strategy can feed management level operational planning, which in turn can feed employee level execution, which can feed management level evaluation, which can feed executive level enterprise strategy. Information generated in each of these stages in an enterprise management cycle can be consolidated and presented by RCT 120.

UI components 308 provide UI patterns used to link new objects and workflow together and generate standardized views into results generated by one or more cross-functional applications. RCT 120 enables generation of new business workflow and ad hoc collaborative workflow. RCT 120 includes procedure templates with pre-configured work procedures that reflect best practices of achieving a work objective. A work procedure can include contributions from several individuals, generation of multiple deliverables, and milestones/phases. Whenever an instantiated business object or work procedure has a lifetime and status, a progress and status of the object or work procedure may be tracked by a process owner or by involved contributors using a “dashboard” that displays highly aggregated data. The dashboard is one UI window provided by UI components 308.

RCT 120 may provide scenarios of related information to a user when possible. Heuristics can be used to identify such relatedness, including: (1) information that is related to the user due to explicit collaborative relationships, such as team/project membership or community membership; (2) information that is similar to a given business object in a semantic space based on text retrieval and extraction techniques; (3) recent objects/procedures of a user; (4) other people doing the same or similar activity (using the same object or procedure template, having the same work set); (5) instances of the same object class; (6) next abstract or next detailed class; (7) explicit relationships on the organizational or project structure; (8) proximity on the time scale; (9) information about the underlying business context; and/or (10) information about the people involved in a collaborative process.

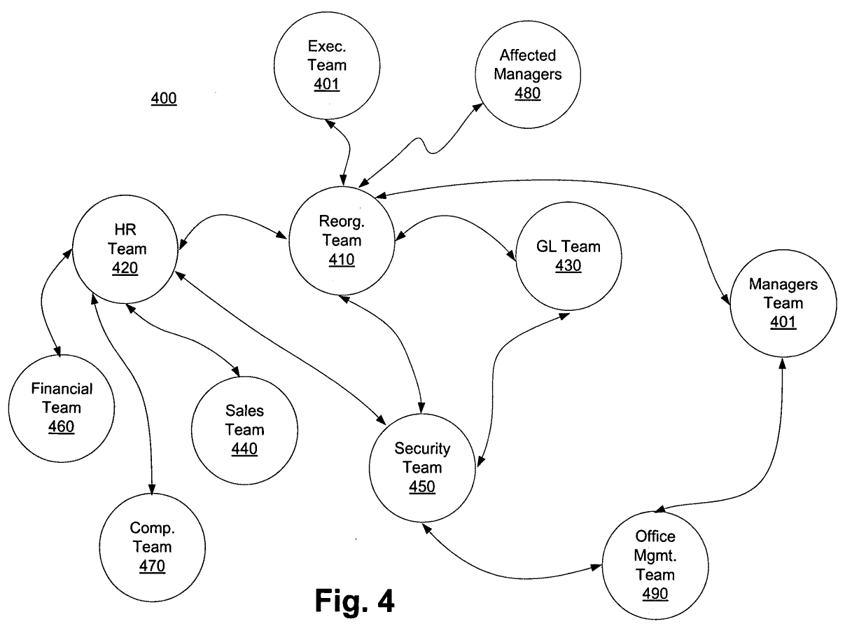

FIG. 4 illustrates an example dependency diagram 400 depicting organizational and departmental dependencies that occur during a reorganization in accordance with an embodiment. In one embodiment, dependency diagram 400 is derived from a reorganization chart by RCT 120 and implemented as a data structure in memory 14 for tracking task dependencies among the various organizational entities. In one embodiment, those organizational entities comprise executive team 401, reorganization team 410, human resources (“HR”) team 420, general ledger (“GL”) team 430, sales team 440, security team 450, financial team 460, compensation team 470, affected managers team 480, and office management team 490. These entities are both providers and consumers of information to and from one another. That is, a first team provides a second team with tasks to implement and information to achieve those tasks. The second team may in turn provide a third team a set of tasks to implement, as its own tasks are dependent upon the tasks assigned to the third team. Once each entity implements the tasks assigned to it, it confirms that those tasks were completed to the providing entity. RCT 120 manages the communication among entities, tasks and restructuring information, and dependencies among those tasks to facilitate the efficient completion of the reorganization. An example is provided below.

In an example embodiment, executive team 401 submits a reorganization chart to reorganization team 410 via RCT 120. This submission instructs the reorganization team 410 to achieve the task of identifying affected cost centers, departments, and managers, and implementing the reorganization. Reorganization team 410 submits the affected cost centers to GL team 430 via RCT 120. GL team 430 realigns cost centers, which may include adding, merging, or deleting cost centers based on the new organization chart. GL team 430 submits the new cost center structure to financial team 460 via RCT 120, and financial team 460 resolves pending transactions and reroutes pending transactions to the appropriate cost center if affected. Financial team 460 confirms to GL team 430 that the restructuring tasks are completed, and GL team 430 in turn confirms to reorganization team 410 that cost centers have been updated, via RCT 120.

Reorganization team 410 also submits information about departments affected by the reorganization to HR team 420 via RCT 120. HR team 420 realigns departments and employees based on the new organization structure, and adjusts the reporting structure of the organization accordingly. HR team 420 submits this information to sales team 440 via RCT 120 so that they can readjust sales territories, quotas, and forecasts accordingly. Sales team 440 confirms that these tasks are completed to HR team 420 via RCT 120. Compensation team 470 receives information from HR team 420 and sales team 440 via RCT 120 in order to update salary and benefits requirements accordingly. Compensation team 470 notifies sales team 440 and HR team 420 that its tasks are complete. Ultimately, HR team 420 confirms to reorganization team 410 via RCT 120 that the HR reorganization tasks are complete.

Reorganization team 410 further submits information about departments affected by the reorganization to security team 450 via RCT 120. Security team 450 creates, deletes, or changes the security roles that are provisioned to employees based on the new organization structure. Additional information regarding the new structure may also come from HR team 420 and GL team 430. Once the new access rights have been determined, security team 450 confirms to its information providers via RCT 120 that the security changes have been implemented.

Reorganization team 410 further submits information about departments affected by the reorganization to affected managers 480 via RCT 120, which are the managers of departments that are undergoing restructuring. The affected managers team 480 adjust their projects, budgets, and personnel based on the new organization structure, and confirms to reorganization team 410 via RCT 120 that their tasks are completed. Affected managers team 480 and security team 450 provide information to office management team 490 so that office managers may reassign office space and provide employees with new entrance security cards where necessary. Ultimately, all of the entities confirm that their tasks are completed, and reorganization team 410 informs executive team 401 that the reorganization is complete.

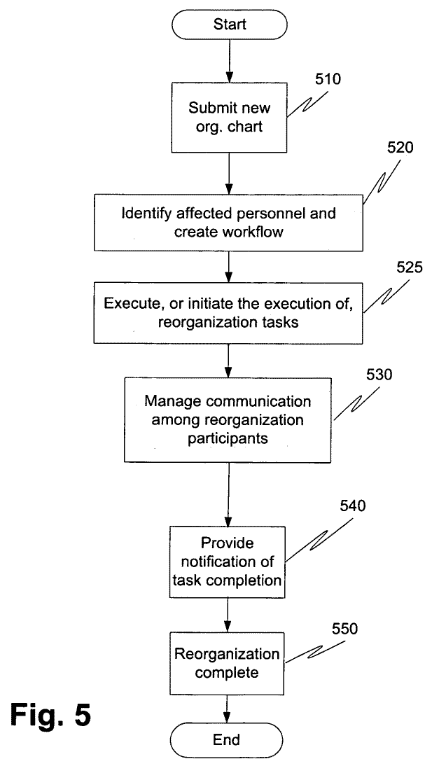

FIG. 5 illustrates a flow diagram of the functionality of RCT 120 in accordance with an embodiment. In one embodiment, the functionality of the flow diagram of FIG. 5 is implemented by software stored in memory and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

Executives, managers and reorganization coordinators decide on a new organization structure, such as reorganization chart 230 of FIG. 2, and input that new structure into RCT 120 (510). RCT 120 derives affected departments and personnel required to complete the reorganization based on the new organization chart and creates an initial workflow model to implement the reorganization (520). For example, RCT 120 may determine that HR, GL, security, and office managers need to perform tasks to implement the reorganization, such as reorganizing departments, implementing security roles, reorganizing cost centers, and consolidating office space. In one embodiment, these tasks are based on predefined templates and business processes associated with a particular reorganization or a particular organizational department. In another embodiment, tasks and business process workflows are defined by a user. Once the tasks have been defined, RCT 120 manages communication among the reorganization participants (530). For example, when a deliverable is required of a reorganization participant, they are alerted of the requirement. A UI, such as one of UI components 308, may provide to a user a unified view of the tasks upon which the user is waiting, and tasks required by the user to complete. After the task is completed, a user informs the requesting reorganization participant via RCT 120 that the task has been completed (540). In one embodiment, RCT 120 tracks the times of task assignment and completion to ascertain which parts of the reorganization are requiring the most time to complete. Once RCT 120 resolves the task dependencies and completion thereof, RCT 120 notifies the reorganization manager that the reorganization is complete (550). Included in the functionality of FIG. 5 may be the actual carrying out the reorganization tasks such as performing the transfers, updating the hierarchies, updating the budgets, etc. (525). Some tasks may be performed by RCT 120, while other tasks may be initiated/triggered by RCT 120.

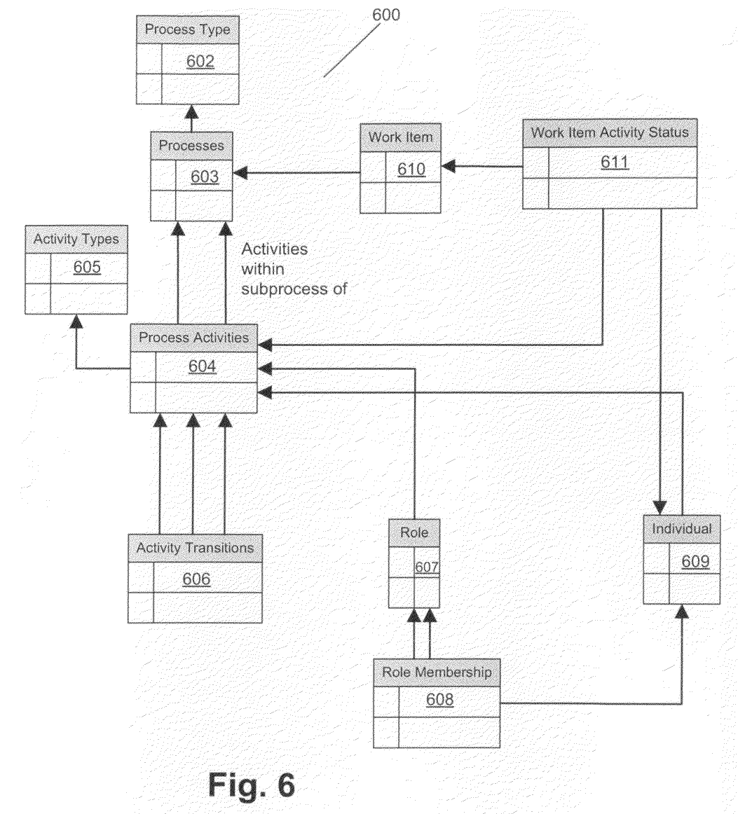

FIG. 6 is a block diagram of an example data structure 600 that can implement the task dependencies of FIG. 4 in accordance with one embodiment. FIG. 6 illustrates reorganizations implemented in a generic work management system.

Reorganization processes are of a process type 602 called “reorganizations”. There can be different reorganization processes 603 for an acquisition, a downsizing, a new business unit, etc. A process is comprised of many activities 604. An example of a process activity 604 for reorganizations is “Create New Department”. A process activity 604 is of a type 605. The type 605 may be a task or a sub-process. An example of a sub-process is “Manage transfers”.

Activities 604 have prerequisites. For example, the “Manage transfers” activity cannot start until the “Create New Departments” activity is completed. Activity transitions 606 may depend on the outcome of a previous activity. For example, a preceding activity to Create New Departments may be “Investigate need for New Departments” with outcomes of “Needed” or “Not Needed”.

An activity 604 is assigned to a role 607 and/or an individual 609 that is a member of that role. An example of a role is a Human Resource (“HR”) Professional. An example of a role membership 608 is “Joe Smith is an HR Professional”. When a process is started a Work Item 610 is established and activities within the process are tracked at Status 611. An example of a Work Item 610 for a reorganizations process is “Company XYZ Acquisition October 2009”. Individuals are assigned work item activities. For example Joe Smith may be assigned the task of “Create New Departments”.

As disclosed, embodiments are a web-based reorganization collaboration tool for managing task dependencies to facilitate the reorganization. Unlike known reorganization methodologies which often rely on unstructured interpersonal communication such as email and phone messages, embodiments provide a structured web-based communication environment in which task dependencies, and thus reorganization bottlenecks, are readily ascertainable. Thus, faster and more efficient reorganization is achieved.

Embodiments can include a number of process definitions whose sub-processes span the departments that use a suite of applications, such as an ERP system, and who do most of the initiation and implementation of the reorganization. One of the process templates starts in the executive team as a response to either a change in strategy or a search for operational efficiency. Embodiments allow a comparison between an “As Is” organization hierarchy and a “To Be” organization hierarchy, and can distill from this comparison the “organizational change”. Embodiments allow the organization change to be reviewed and, if approved, to initiate the reorganization process. In one embodiment, participants in this process can include a reorganization coordinator, Financial Analyst, General Accountant, Human Resource Specialist, Security Manager, many line managers and many employees. Each is notified at the appropriate phase of the overall process.

In one embodiment, a first phase begins when the program manager is given a first cut project budget that has been modeled in the template for the type of reorganization. The program manager can then identify the people and departments involved in the reorganization. Embodiments note the tasks as complete and informs the human resource managers of the affected departments. Meanwhile, the initiation of the process will have also been routed to Financial Planning and Analysis, where the “To Be” organization hierarchy can be imported into Financial Modeling software and impacts on the chart of accounts definition derived, financial reporting hierarchies changed and budgets and forecasts moved. Once complete, the changes to the line manager's authorization to see financial reports is routed to security administration and the tasks in Financial Planning and Administration are marked as complete. Approvals that were charged to responsible managers whose cost centers have changed are redirected to the new responsible manager. The human resources department will be notified on completion of the “As is” and “To Be” organization structure. The human resources specialist can review the impacts to departments, departmental managers and departmental hierarchy and make the changes to reporting relationship between managers and subordinates automatically through embodiments of the invention. Once the changes have been imported, the task may be marked as complete and Line Managers, Space Planning and Communications representatives may be notified of the pending changes.

Because embodiments are integrated with other enterprise applications, such as an ERP system, the product of financial planning activities can be easily consumed into the transactions systems for the creation of departments and organization hierarchies, the creation or changes to cost centers and cost center hierarchies, changes to authorization to financial reporting data and movement of budgets, headcount and revenue forecast.

Because the movement of people has occurred through a reorganization process in one embodiment, an integrated system can compare the existing organization with the results in prior periods. For example, if a vice president (“VP”) of development of a company has had a significant number of staff reorganized under him, he/she can review the financial results against prior year and see the results of his current organization year on year. Without the knowledge in the integrated system that a reorganization has occurred, the VP of development will see an increase in headcount costs, even though that increase is due to a reorganization and should not be counted against the VP.

The role associated with an activity in the reorganization process may be independant of the organization unit. For example, an organization change must be approved by a VP in Human Resources. The role associated with an activity in the reorganization process may be dependant on an organization unit that is subject to change. For example, the reorganization must be approved by the departmental manager to whom new organization units will be added.

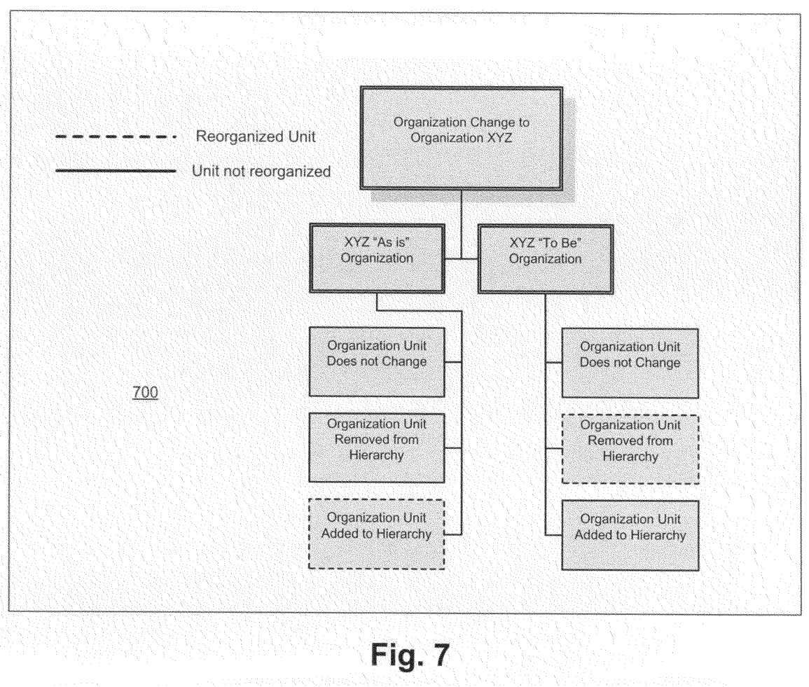

In one embodiment, RCT 120 compares the “To Be” organization chart with the “As Is” organization chart and calculates, for example, the changes to the organization structure, the list of affected organization units, and the managers that must be informed of the organizational change. RCT 120 further provides a user interface so a user can visualize the “As Is” and “To Be” organization charts and the derived list of organizational changes. FIG. 7 illustrates a user interface 700 that displays the “As Is” and “To Be” organization charts in accordance to one embodiment. As shown in FIG. 7, a dotted line indicates a reorganized unit, and a solid line indicates a unit that is not reorganized.

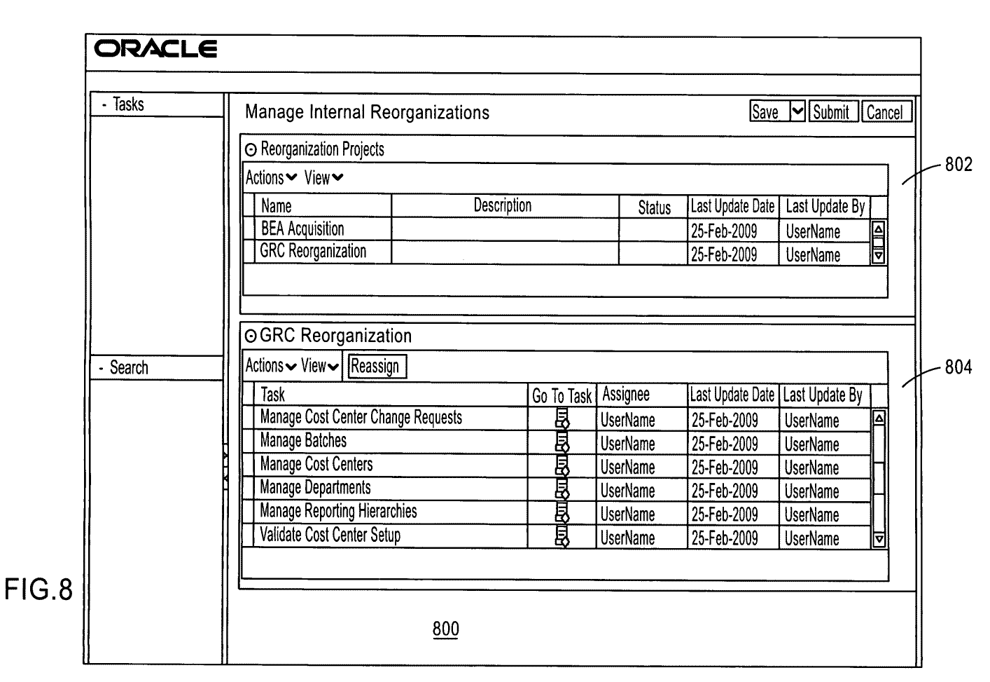

FIG. 8 illustrates a user interface 800 that provides a unified view of tasks for a reorganization in accordance to one embodiment. The reorganization projects are listed and are selectable in table 802. When a project is selected (for example, the “GRC Reorganization”), the tasks for that project are listed in table 804. When a task is selected, information for that task, such as the responsible party for the task, the status of the task, the dependency of that task on other tasks, etc.

Some embodiments of the invention have been described as computer-implemented processes. It is important to note, however, that those skilled in the art will appreciate that the mechanisms of the invention are capable of being distributed as a program product in a variety of forms. The foregoing description of example embodiments is provided for the purpose of illustrating the principles of the invention, and not in limitation thereof, since the scope of the invention is defined solely by the appended claims.

What is claimed is:

1. A computer-readable medium having instructions stored thereon that, when executed by a processor, cause the processor to facilitate organizational restructuring by:
receiving a new structure representing the organizational restructuring;
applying a plurality of business processes defining a plurality of tasks that implement the organizational restructuring;
managing communication among a plurality of organizational entities based upon a task dependency model for the plurality of tasks; and
determining, using the task dependency model, that the organizational restructuring is complete.

2. The computer-readable medium of claim 1, wherein the managing communication includes providing a user interface that displays a task status for a user, wherein the task status includes tasks assigned to the user and tasks assigned by the user.

3. The computer-readable medium of claim 1, wherein the business processes are based on a template.

4. The computer-readable medium of claim 1, wherein the business processes are provided by a user.

5. The computer-readable medium of claim 1, wherein the task dependency model is implemented by a data structure that defines at least a first task, a second task depending on completion of the first task, and a third task upon whose completion the first task depends.

6. The computer-readable medium of claim 1, wherein the organizational restructuring is one of a merger, acquisition, divestiture or internal reorganization.

7. The computer-readable medium of claim 1, wherein organizational entities include at least one of: a human resources department, a security department, a general ledger department, an office management department, a sales department, a financial planning and analysis department and a consolidations department.

8. The computer-readable medium of claim 7, wherein the plurality of tasks includes cost center or department restructuring.

9. The computer-readable medium of claim 7, wherein the plurality of tasks includes security role provisioning.

10. The computer-readable medium of claim 7, wherein the plurality of tasks includes personnel realignment.

11. A computer-implemented method for facilitating organizational restructuring, comprising:
receiving an organizational chart representing the organizational restructuring;
applying a plurality of business processes defining a plurality of tasks that implement the organizational restructuring;
managing communication among a plurality of organizational entities based upon a task dependency model for the plurality of tasks; and
determining, using the task dependency model, that the organizational restructuring is complete.

12. The computer-implemented method of claim 11, wherein managing communication includes providing a user interface that displays a task status for a user, wherein the task status includes tasks assigned to the user and tasks assigned by the user.

13. The computer-implemented method of claim 11, wherein the task dependency model is implemented by a data structure that defines at least a first task, a second task depending on completion of the first task, and a third task upon whose completion the first task depends.

15. The computer-implemented method of claim 11, wherein organizational entities include at least one of: a human resources department, a security department, a general ledger department, an office management department, and a sales department.

16. A system for facilitating organizational restructuring, comprising:
a reorganization collaboration tool that manages a reorganization workflow by assigning a plurality of tasks and confirming completion of the plurality of tasks, and managing communication among a plurality of organizational entities;
a memory storing a task dependency data structure for storing dependency relationships among the plurality of tasks; and
a user interface that displays a task status to a user.

17. The system of claim 16, wherein the organizational entities include at least one of: a human resources department, a security department, a general ledger department, an office management department, and a sales department.

18. The computer-readable medium of claim 1, further comprising providing a user interface that displays As Is and To Be organization charts.
